(19) United States
(12) Patent Application Publication
(10) Pub. No.: US 2010/0043241 A1
(43) Pub. Date: Feb. 25, 2010

(54) CAN OPENER

(76) Inventor: Rein Randmae, Northport, NY (US)

Correspondence Address: TUTUNJIAN + BITETTO, P.C., 20 CROSSWAYS PARK NORTH, SUITE 210, WOODBURY, NY, 11797, US

(21) Appl. No.: 12/196,679

(22) Filed: Aug. 22, 2008

(51) Int. Cl. B67B 7/48

(52) U.S. Cl. 30/443

(57) ABSTRACT

A beverage can opener having a body that includes a tab engaging pawl, and an opposing punch opening assist pawl that is offset from the tab engaging pawl. The tab engaging pawl is inserted into the beverage can opening tab from the drinking hole side of the can, and functions to increase the leverage and thereby the opening action of the can opening tab.

### BACKGROUND

2. Technical Field

The present principles relate to can openers. More particularly, they relate to a beverage can opener.

2. Description of related art

There are many known devices for assisting in the opening of a beverage can. These devices are generally designed to assist the user in getting underneath the existing opening tab and providing an extension of the same in order to help the user open the can.

### SUMMARY

The present principles provide a beverage can opener that provides increased leverage to a user attempting to open a beverage can, while at the same time making it simple and easy to use.

According to one aspect, the beverage can opener includes a tab engaging pawl configured to engage a beverage can opening tab, and a punch assist pawl extending in an opposite direction from said tab engaging pawl, wherein said tab engaging pawl engages the beverage can opening tab from a drinking hole side of the beverage can.

In one embodiment the tab engaging pawl engages the beverage can opening tab by passing through a hole in the beverage can opening tab.

A handle is connected to the tab engaging pawl and the punch assist pawl. The tab engaging pawl and the punch assist pawl extending outward from a distal end of said handle, wherein the punch assist pawl is offset from said tab engaging pawl such that the punch assist pawl is disposed above said tab engaging pawl on said handle.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1b is perspective view of the beverage can opener according to an implementation of the present principles;

FIG. 1b is a side view of the beverage can opener according to an implementation of the present principles;

FIG. 2a is a plan view of the operation of the beverage can opener according to a first implementation of the present principles;

FIG. 2b is a plan view of the operation of the beverage can opener according to a second implementation of the present principles;

FIG. 3a is plan view of the operation of the beverage can opener according to the first implementation of the present principles;

FIG. 3b is a plan view of the operation of the beverage can opener according to the second implementation of the present principles;

FIG. 4a is a plan view of the operation of the beverage can opener according to the first implementation of the present principles; and

FIG. 4b is a plan view of the operation of the beverage can opener according to the second implementation of the present principles.

### DETAILED DESCRIPTION

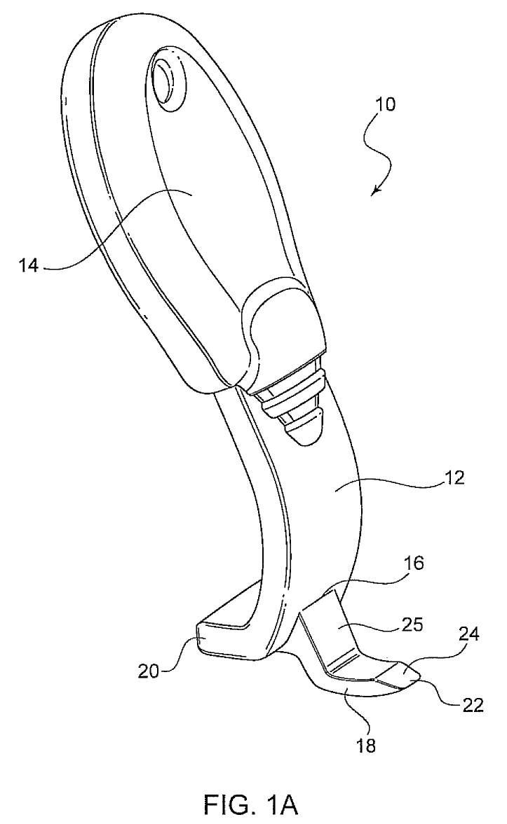

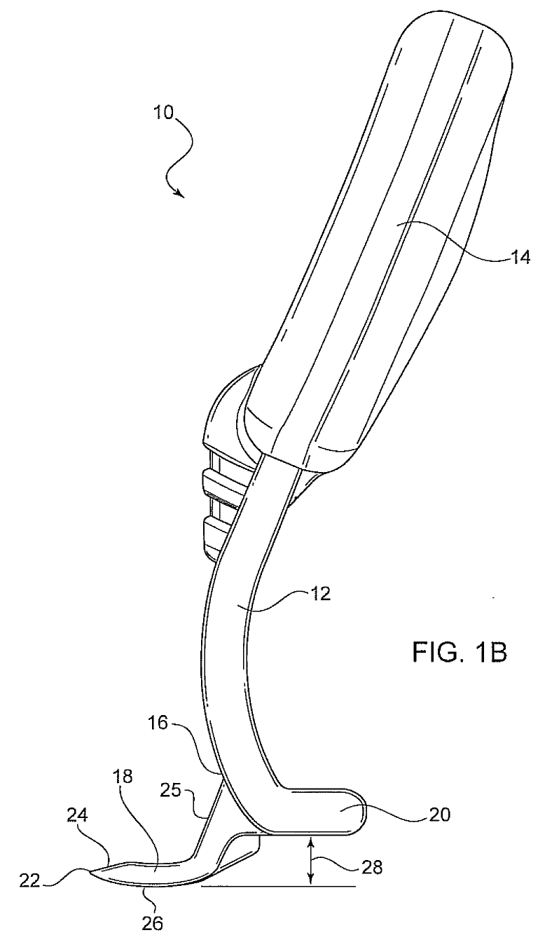

Referring to FIG. 1a and 1b, there is shown the beverage can opener 10 according to as aspect of the present principles. The opener 10 has a body 12 with a handle 14, a tab engaging pawl 18 and a punch opening assist pawl 20 oppositely arranged from the tab engaging pawl 18 and offset 28 from the same. The tab engaging pawl 18 includes a tip 22 configured to be inserted under a punch opening tab 34, a ramp lice flat surface 24 for assisting the insertion of the pawl 18 under the opening tab 34, and a transition area 25 connecting the pawl 18 to the body 12 at a transition point 16. The punch assist pawl 20 extends in the opposite direction (i.e., 180 degrees) than the tab engaging pawl 18. The underside 26 of the tab engaging pawl 18 includes a slight curvature to assist in the proper insertion of the tip 22, and thereby the orientation of the pawl 18 with respect to the tab 34.

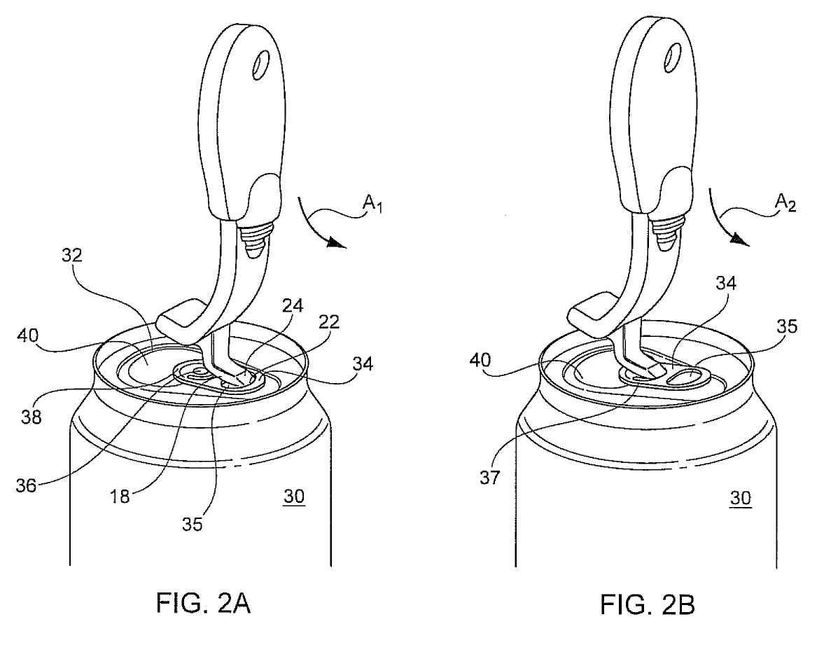

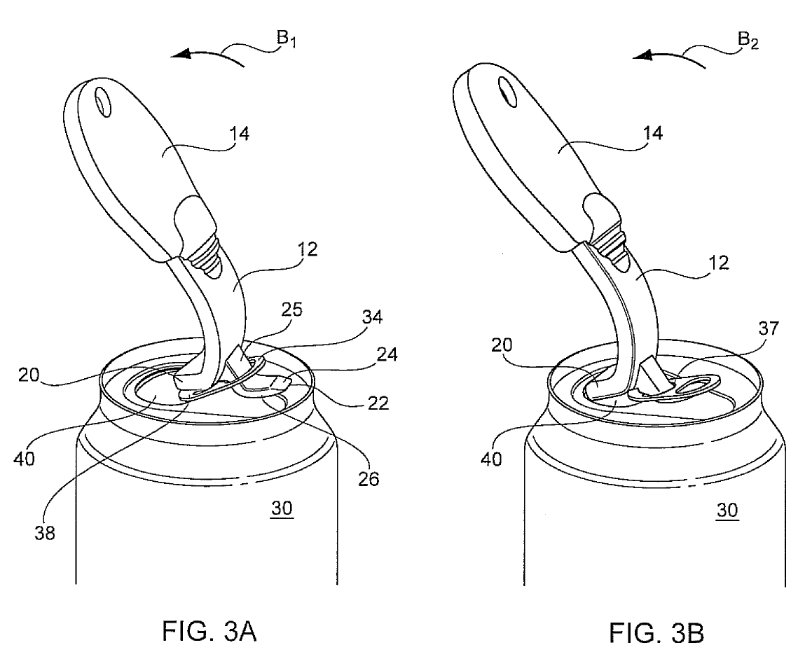

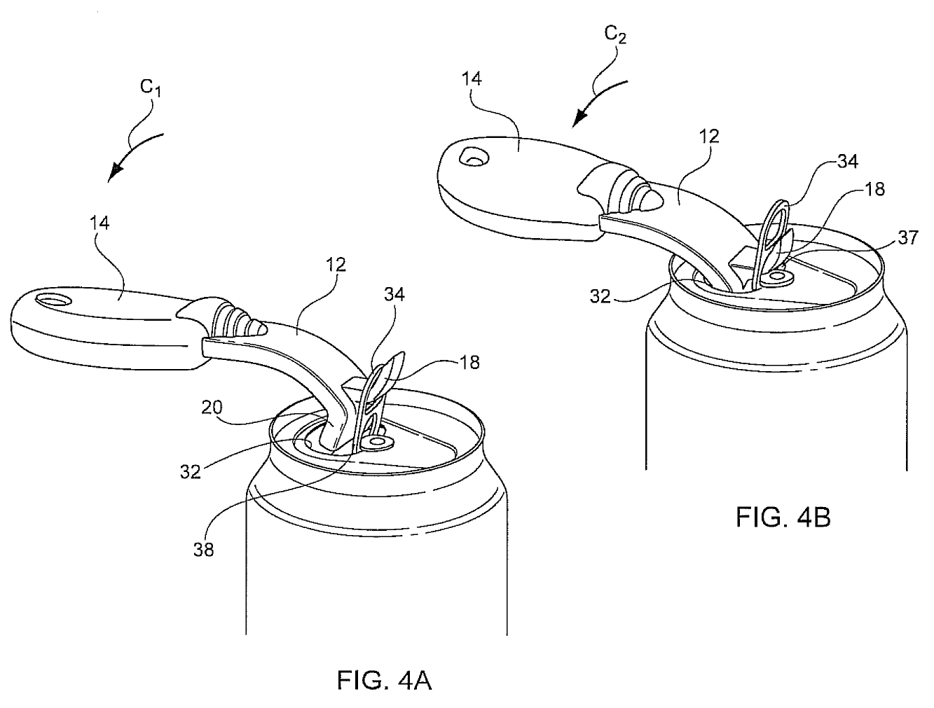

In accordance with one implementation of the present principles, the opener 10 is designed to engage the can opening tab 34 and provide the user with increased ease and comfort in opening the same. FIGS. 2a, 3a and 4a show this preferred implementation of the opener 10 according to the present principles. FIG. 2b, 3b and 4b show the opener 10 in a secondary application, according to the present principles.

According to the preferred implementation, and referring now to FIGS. 2a, 3a and 4a, the tip 22 is inserted into the hole 35 of the opening tab 34 such that the flat surface 24 passes through the hole 35 from the top and passes under the rim formed by the hole 35. This action is shown by the direction arrow A1 in FIG. 2a. As the tab engaging pawl 18 is passed through hole 35, the underside curvature 26 of the pawl 18 causes the tab 34 to raise about its pivot point 36. As this point (i.e., the end of the A1 motion), the punch assist pawl 20 comes into contact with the tab end 38 which is adapted to press the during hole punch 40 into the drinking hole 32. As the opener 10 is moved in the direction B1, the punch assist pawl 20, in conjunction with the tab end 38, applies pressure to the drinking hold punch 40 and once die seal is broken on the punch 40, the handle 14 of the opener is moved in the direction C1 to cause the pawl 20 with tab 34 to press the punch 40 into the can and open the drinking hole 32. In this manner, the user can easily open the beverage can by utilizing the opener 10 with out fear of breaking the tab 34, or otherwise hurting their finger (e.g., breaking a fingernail, etc.).

In another contemplated implementation, the opener 10 can be used to “save” a beverage can where, for whatever reason, tie tab 34 failed to function properly and fully press the punch 40 into the can and open the drinking hole 32. Often times, this results in the can being thrown away, or alternatively, the user attempts to use one of their fingers to assist in pressing punch 40 into the can, thereby increasing the risk for injury. FIGS. 2b, 3b and 4b show an alternative use for the opener 10 where tie tip 22 of tab engaging pawl 18 is inserted into tie partial hole 37 where the pivot 36 connects the tab 34 to the can 30.

The tab 34 has been lifted at this point by the user, and has failed to function properly. As such, the insertion of tab engaging pawl 18 will be relatively simple. Once fully inserted, the punch assist tab 20 will extend beyond die punch engaging end 38 of tab 34 and will actually engage the punch 40 directly. By pivoting the handle 14 in die direction B2, C2, the punch assist tab 20 will forcefully press tie punch 40 into the can, and thereby open the drinking hole 32. This allows the user to “save” an otherwise unopenable can, without requiring the dangerous use of a finger, or some other implement not configured for the same.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of die claims appended hereto.

What is claimed is:

1. A beverage can opener comprising:
a tab engaging pawl configured to engage a beverage can opening tab; and
a punch assist pawl extending in an opposite direction from said tab engaging pawl;
wherein said tab engaging pawl engages the beverage can opening tab from a drinking hole side of the beverage can.

2. The beverage can opener of claim 1, wherein said tab engaging pawl engages said beverage can opening tab by passing through a hole in the beverage can opening tab.

3. The beverage can opener of claim 1, further comprising a handle connected to said tab engaging pawl and said punch assist pawl, said tab engaging pawl and said punch assist pawl extending outward from a distal end of said handle.

4. The beverage can opener of claim 3, wherein said punch assist pawl is offset from said tab engaging pawl such that said punch assist pawl is disposed above said tab engaging pawl on said handle.

5. The beverage can opener of claim 1, wherein said punch assist pawi is disposed at an angle of 180 degrees from sald tab engaging pawl.
